(19) United States
(12) Patent Application Publication
(10) Pub. No.: US 2009/0132230 A1
(43) Pub. Date: May 21, 2009

(54) MULTI-HOP NATURAL LANGUAGE TRANSLATION

(76) Inventors: Dimitri Kanevsky, Ossining, NY (US); Bhuvana Ramabhadran, Mount Kisco, NY (US); Mahesh Viswanathan, Yorktown Heights, NY (US)

Correspondence Address: DUKE W. YEE, YEE AND ASSOCIATES, P.C., P.O. BOX 802333, DALLAS, TX, 75380, US

(21) Appl. No.: 11/940,748

(22) Filed: Nov. 15, 2007

(51) Int. Cl. G06F 17/28

(52) U.S. Cl. 704/2; 704/E15.003

(57) ABSTRACT

Illustrative embodiments provide a computer implemented method and apparatus, in the form of a data processing system, and a computer program product for optimizing a natural language translation. In one illustrative embodiment, the computer implemented method comprises receiving a request from a requester, wherein the request comprises source language data, an indication of a source language and a destination language, and determining whether a translation between the source language and the destination language is needed. Identifying a mapping between the source language and the destination language includes a set of hops, the method, responsive to a determination that the translation is needed, translates the source language data into a destination language data associated with each successive hop in the set of hops in the mapping and returns the destination language data to the requester at a destination hop.

### BACKGROUND OF THE INVENTION

1. Field of the Invention

The present invention relates generally to an improved data processing system, and in particular to a computer implemented method, an apparatus, and a computer program product for optimizing natural language translations involving multiple hops.

2. Description of the Related Art

In the current environment of information technology, online customer service and helpdesk support personnel, in many organizations, provide assistance to users from around the world and around the clock. The default language for communication between the users and the support personnel has been limited to English. Communication may be in a number of forms including email, chat, instant message, transcribed voice mail, and fax.

Support centers responsible for local users offer support in the language of the local user. In cases where the support center has to support international customers and users who either have a limited exposure to another language or none at all, communication becomes an issue.

For example, an organization based in the United States or Western Europe may offer helpdesk support by hiring English speaking personnel in India. This type of support, however, does not help the non-English speaking customer or user. Although English appears to be the language of online users, English is only, at best, a second language of most of the population of the world. Companies in France, Germany, and Italy, for example, cannot use services of English speakers in India if these companies need to support their users and customers in the native languages of the users and customers in those countries. In a similar example, companies in the United States using English speaking support personnel in India cannot support their Spanish speaking customers and users.

Current support scenarios include use of voice, email, and chat. Chatting with support personnel has become a popular offering in which a user and the support personnel may communicate, typically by keyboard input of messages, in near real time.

The current environment then limits the languages in which support may be offered and reduces the quality of support. For example, if the skill for resolving an information technology issue lies within one country, but the support relied upon is in another country due to a language issue, support effectiveness is reduced.

Therefore, it would be advantageous to have a computer implemented method, apparatus, and computer program product providing support services that over come the problems described above.

### SUMMARY OF THE INVENTION

Illustrative embodiments provide a computer implemented method, an apparatus, in the form of a data processing system, and a computer program product for optimizing a natural language. In one illustrative embodiment the computer implemented method comprises receiving a request from a requester wherein the request comprises source language data, an indication of a source language and a destination language, determining whether a translation between the source language and the destination language is needed, and identifying a mapping between the source language and the destination language wherein the includes a set of hops, in response to a determination that the translation is needed. The computer implemented method further comprises translating the source language data into a destination language data associated with each successive hop in the set of hops in the mapping by a set of translators, and returning the destination language data to the requester at a destination hop.

In another illustrative embodiment, an apparatus comprises a bus, a memory connected to the bus, a persistent storage connected to the bus, wherein the persistent storage contains computer usable program code therein, a communications unit, a display unit, and a processor unit connected to the bus. The processor unit executes the computer usable program code to receive a request from a requester wherein the request comprises source language data, an indication of a source language and a destination language to determine whether a translation between the source language and the destination language is needed. The processor unit executes the computer usable program code to further identify a mapping between the source language and the destination language wherein the mapping includes a set of hops, in response to a determination that the translation is needed and translating the source language data into a destination language data associated with each successive hop in the set of hops in the mapping by a set of translators. The processor unit executes the computer usable program code to further return the destination language data to the requester at a destination hop.

In another illustrative embodiment, the computer program product comprises a computer usable recordable type medium having computer executable program code tangibly embodied thereon, the computer executable program code comprises computer executable program code for receiving a request from a requester wherein the request comprises source language data, an indication of a source language and a destination language and computer executable program code for determining whether a translation between the source language and the destination language is needed. The computer program product further comprises computer executable program code for identifying a mapping between the source language and the destination language, wherein the mapping includes a set of hops, in response to determining the translation is needed, computer executable program code for translating the source language data into a destination language data associated with each successive hop in the set of hops in the mapping by a set of translators, and computer executable program code for returning the destination language data to the requester at a destination hop.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram of components for a translation service in accordance with illustrative embodiments;

FIG. 4 is a tabular view of routing tables in accordance of the translation service of FIG. 3, in accordance with illustrative embodiments;

FIG. 5 is a block diagram of the translation service of FIG. 3, in accordance with illustrative embodiments;

FIG. 6 is a block diagram of a routing service of the translation service of FIG. 5, in accordance with illustrative embodiments;

FIG. 7 is a block diagram of a predictability estimator of the translation service of FIG. 3, in accordance with illustrative embodiments;

FIG. 8 is a block diagram of an adjustment service for a translation service of FIG. 3, in accordance with illustrative embodiments;

FIG. 9 is a flowchart of an overview of a process of a translation service of FIG. 3, in accordance with illustrative embodiments;

FIG. 10 is a flowchart of a request receiving process of a translation service of FIG. 3, in accordance with illustrative embodiments;

FIG. 11 is a flowchart of a routing process of a translation service of FIG. 3, in accordance with illustrative embodiments; and

FIG. 12 is a flowchart of a translation process of a translation service of FIG. 3, in accordance with illustrative embodiments.

### DETAILED DESCRIPTION OF THE PREFERRED EMBODIMENT

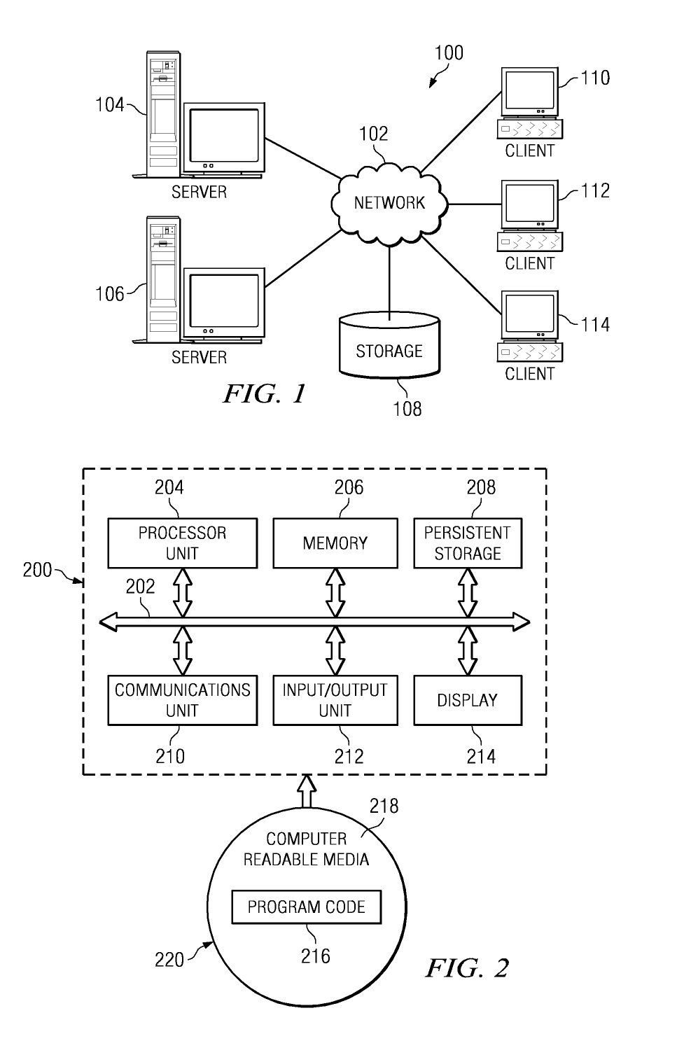

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the different illustrative embodiments.

Illustrative embodiments provide a network, such as that in FIG. 1, of connected translation resources, including automatic machine implementations, as well as manual operations, and combinations thereof, for example, to create a communication link between a user and a help desk support personnel. In one example, the help desk may be supported on server 106, translation services on server 104, while a user is represented by client 110 communicating through network 102 to a support person on client 112. The translation resources cooperate to translate online information, including, but not limited to, chats and emails, in substantially real time between a source language of a client, such as client 110 and a destination language of support personnel on server 106 or another client, such as client 112. The translation between client 110 and the support person on client 112 may have to traverse a set of hops using a set of translators. A set of hops is one or more hops. The term “hop” is used to suggest that a cascaded set of translations may be required to go from a source language to a target or destination language. The set of translators comprises machine translators, human translators, and combinations of human and machine translators. Machine translators may also be referred to as automatic translators.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer recordable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

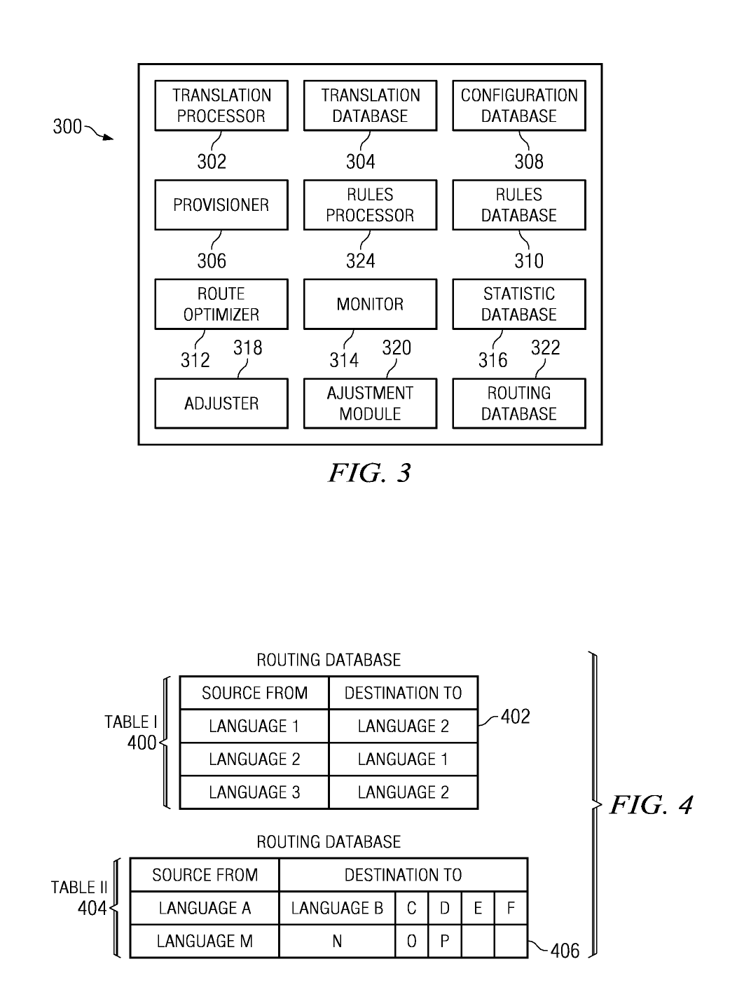

With reference to FIG. 3, a block diagram of components for a translation service in accordance with illustrative embodiments is shown. Components of translation service 300 may be implemented on a data processing system, such as data processing system 200 of FIG. 2. Translation service 300 comprises a number of components including a translation processor 302, provisioner 306, route optimizer 312, monitor 314, adjuster 318, and adjustment module 320 and rules processor 324. In addition, persistent storage is provided for data used during the translation process, in the form of components, comprising translation database 304, configuration database 308, rules database 310, statistics database 316, and routing database 322.

Translation processor 302 provides the capability to translate a supported source language into a destination language. The processor uses the resources of the translation database 304. Translation processor 302 may be entirely machine based or a combination of machine assisted and human translation. At any given stage in the translation network, translations may be performed manually, that is, a human may review the incoming statements and translate them as best as can be done. Translation database 304 comprises words, phrases, and other semantic and syntactic resources as required to effectively translate a source language element in to a destination language element. Language elements may comprise a word, phrase sentence, or other grammatical construct of a language.

For example, a language element may be a description of a machine, identifying and describing a part, such as a display monitor, or it may be a phrase defining an activity or operation, such as searching for a keyword in a file. Translation database 304 as used may also be referred to as a translation memory. Translation database 304 typically contains the results of previous translations between pairs of languages as a means of increasing the capability of the translation processor and reducing the time to translate.

Provisioner 306 typically works in conjunction with configuration database 308 to reduce the time required to make a needed resource available. For example, when it is determined that a train of visitors is about to arrive and use a kiosk, a set of operations may be performed by the provisioner to ready translation resources. In another example, when workers are about to arrive at a translation center, provisioner 306 may perform updates to the local resources prior to the start of business, based on information in the configuration database 308 and event timing.

Route optimizer 312 performs routing analysis and selection to determine an optimal route between resources in the performance of a source language to destination language translation. Routing may typically be between a first and second language as in the case of a single hop or direct translation. Routing may also require multiple hops translating from hop to hop through a series of hops to arrive at the desired destination language.

Route optimizer 312 typically uses statistics compiled in statistics database 316 by monitor 314 in combination with information contained within routing database 316. Monitor 314 monitors the translation processor 302 and translation database 304 to accumulate data including translation errors, path lengths and duration for analysis and modifying the processes.

Adjuster 318 and adjustment module 320 provide a capability of adjusting or modifying the results of the translation processor. Adjustments are typically made based on information collected by the monitor 314. Adjustment module 320 is typically positioned between translation hops to effectively adjust the output of one hop before it is input into the next hop for processing. The adjustment capability of adjuster 318 enables incremental adaptation of the translation processor 302 output to provide a more accurate translation as a source element traverses the translation path.

Rules processor 324 may be invoked at various steps within translation service 300 to cause conditional processing to occur. Rules processor 324 uses rules database 310 to alter the performance of the translation service. Rules are typically defined in the form of a condition and resulting action. When the condition is met the action specified is performed. For example, a rule may state a set of conditions, such as when time of day is “start,” resource is “translation processor,” source language is “English,” and destination language is “Dutch” to perform the action of invoking the provisioner to load the needed translation resources for English to Dutch translation. Rules may have a set of conditions and corresponding set of actions.

Rules processor 324 may typically be used for invoking other operations as needed, such as requesting route optimizer 312 to perform a route calculation, or in turn, route optimizer 312 may call upon rules processor 324 to process information needed by the route optimizer.

With reference to FIG. 4, a tabular view of routing tables for a translation service 300 of FIG. 3, in accordance with illustrative embodiments is shown. Two types of tables are illustrated. Table 400 or Table I, depicts a single hop or one-to-one relationships, while table 404 or Table II, depicts multi-hop or multiple hop relationships. The multi-hop requirements typically need to have a set of translation sites to perform the required translation because a direct translation between the source and destination language does not exist. Tables are used in the illustrative example, but other persistent storage repositories including database, files, lists, and specific path statements may also be used to contain the desired information.

Row 402 of table 400 shows a single hop route from “Language 1” to “Language 2”. Other examples are provided, but in each case the source from and destination to are limited to a single pair of languages. Row 406, on the other hand, illustrates a multi-hop or multiple hop instance of language translation. In row 406, source from “Language M” must traverse through a series of translation hops of languages “N”, and “O” to arrive at destination hop “P”. The table may be used as an indexing mechanism to determine a path needed to accomplish a requested translation wherein there is no direct path between a source and destination language.

For example, a rule may be defined to use Table I, table 400 for a language translation involving a known grouping of languages. In this case, if both the source and destination language belong to the grouping, a selection from among the group, creates an intermediate result, until the desired translation results. This example may be shown when there is no direct English to German translation, but that the languages are from the same group look for an intermediate result. An intermediate result would comprise English to French and French to German combinations, with French being viewed as a pivot language in this case.

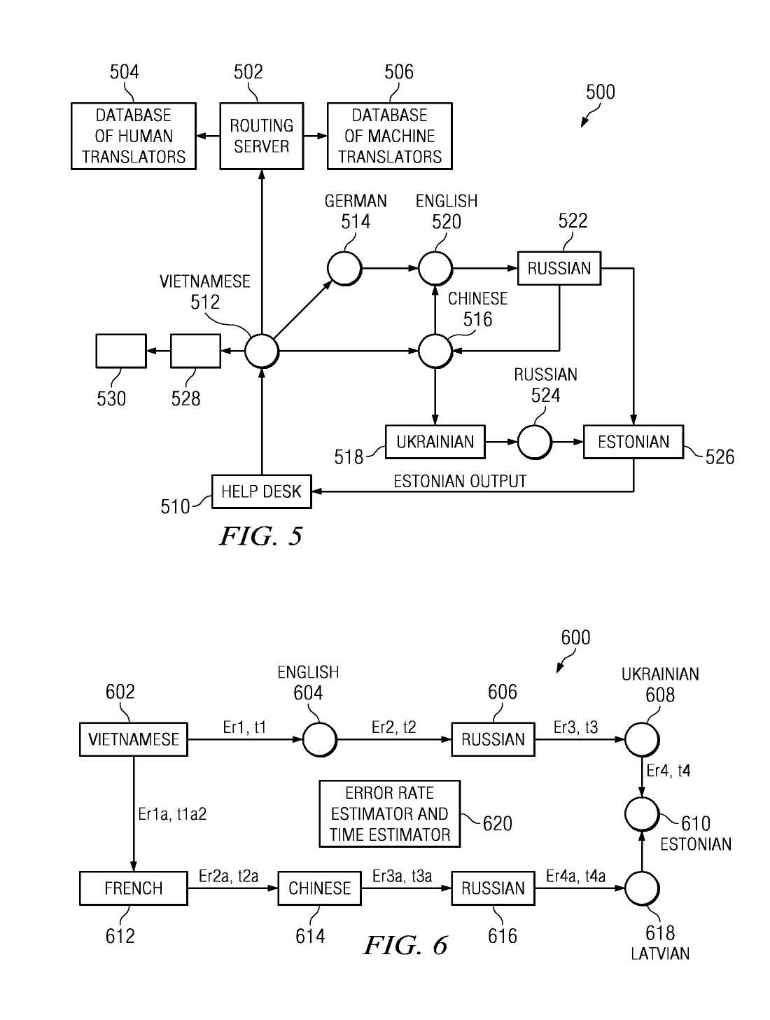

With reference to FIG. 5, a block diagram of the translation service 300 of FIG. 3, in accordance with illustrative embodiments is shown. The example 500 illustrates receiving a request at help desk 510 in Vietnamese 512. This request is ultimately responded to by support personnel using Estonian 526. The direct language translation of Vietnamese to Estonian was not available, as indicated by the multiple hops. The translation traversed the path of German 514, and English 520, to Russian 522, Chinese 516, Ukrainian 518 and Russian 524.

Routing server 502 typically uses route optimizer 312 of FIG. 3 to determine the optimal route. Routing determination typically involves consideration for translation resources available as in the form of a database of human translators 504 as well as the database of machine translators 506.

For example, a helpdesk support person receives a request in Vietnamese, whereas the support person handles Estonian. The routing server which maintains an active list of currently available translation resources, human and automatic by machine, first maps all paths from source to destination language, requiring a complete path from Vietnamese to Estonian. Abortive paths are calculated using hops 528 and 530, but discarded. An optimal route may be calculated as Vietnamese to Chinese to English to Russian to Estonian by hops 512, 516, 522 to 526, but longer paths may exist as well. Normally, the shorter the path, the better since machine translation is not perfect.

While computing the best path from source to destination, the routing server may typically consider the availability of human and machine translators. Machine translators typically have a built-in translation accuracy predictor. Human translators, on the other hand, may typically translate with near complete accuracy capturing even the nuances of the source language. Hence, a longer translation path, one that includes more hops, may be tolerated or even desirable if there are human translators in the path.

A route optimization algorithm will typically be biased towards using human translators due to their effectiveness. Effective use of human translators may be one typical explanation for choosing a longer path of hops Russian 522, Chinese 516, Ukrainian 518, Russian 524, and Estonian 526 over the path having hops 522 to 526. The latter path may include less accurate translation than that of the longer path which may include one or more human translators boosting the aggregated accuracy and reducing the overall error rate.

With reference to FIG. 6, a block diagram of a routing service for a translation service of FIG. 5, in accordance with illustrative embodiments is shown. In FIG. 6, the example 600 shows the calculation of a route from a starting point of Vietnamese 602 by way of two paths to a destination of Estonian 610. Example 600 shows factors of error rate, as in “Er1” and time, as in “t1” used in the analysis of the optimal route. The optimal path may typically be defined as that which has the least time and fewest errors. Alternatively, accuracy may take priority over time resulting in longer durations, but higher quality translations.

Error rates and duration statistics may be captured by monitor 314 and maintained in statistics database 316 as previously described in FIG. 3. Given a desire to minimize error and time, the error rate and time estimator 620 portion of route optimizer 312 of FIG. 3 would determine the better path from Vietnamese 602 through English 604, Russian 606, and Ukrainian 608 to Estonian 610. The alternate path Vietnamese 602, through French 612, Chinese 614, Russian 616 and Latvian 618 to Estonian 610 appears to have either a higher error rate or duration or a combination of the two. If another factor, such as availability was introduced and a translation resource, such as Ukrainian 608 was no longer available, the alternate path would be chosen.

If a translation resource was to become unavailable, or either the source or destination requirements changed the router would be notified and reset to consider the new factors and recalculate the optimal routing. Reset may also occur, for example, if a threshold was met causing a recalculation of the route. For example, if an error threshold was specified as two percent and was exceeded, a rule may be invoked to select a human translator as a replacement hop, causing the routing to be recalculated.

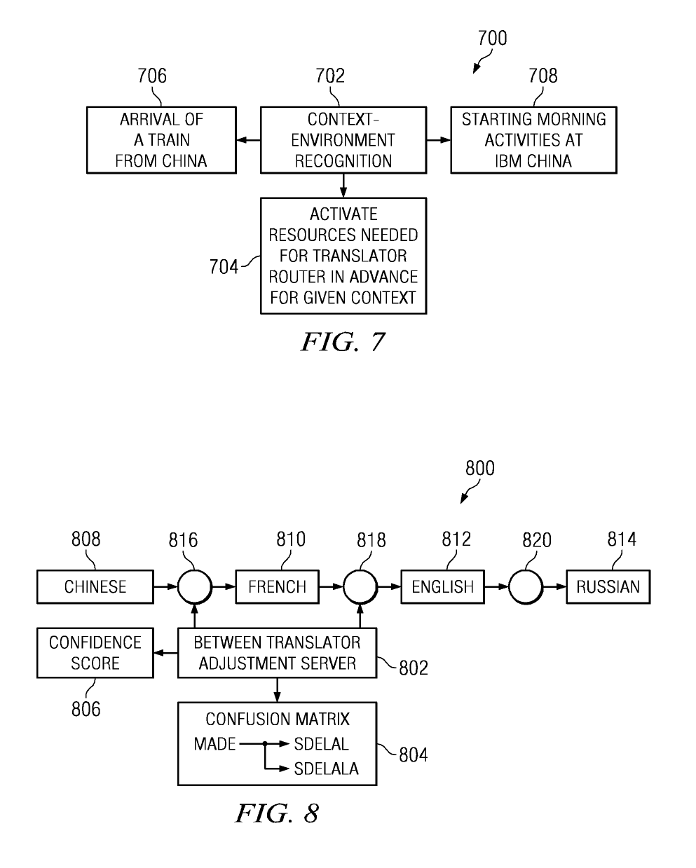

With reference to FIG. 7, a block diagram of a predictability estimator for a translation service 300 of FIG. 3, in accordance with illustrative embodiments is shown. The predictability service 700 is a portion of provisioner 306 of FIG. 3. Predictability service 700 analyzes information related to resources to provide a capability to anticipate the need for the identified resources. When a need is anticipated, the identified resources may be provisioned and activated in advance of actual use. The prior activation may be performed in parallel with other processing to reduce the time to actually use the requested resources.

For example, context-environment recognition 702 may be established as an event listener. Events, such as arrival of a train from China 706 or starting morning activities at IBM China 708 may be used as triggers to send alerts to context-environment recognition 702. Provisioner 306 of FIG. 3 then would act upon the events as indicated by activating resources needed for translator router in advance for given context 704.

With reference to FIG. 8, a block diagram of an adjustment service for a translation service of FIG. 3, in accordance with illustrative embodiments is shown. The figure illustrates use of adjustment modules to modify translations between translators. Translations are modified to provide more accurate translation prior to input at a next translation site.

For example, in adjustment service 800, between translator adjustment server 802 performs modification also known as adjustments to translations to reduce errors in the translated material. A confusion matrix in which phrases may be selected based on additional information may be used. In the example, a word “made” when translated into Russian may have different outputs depending upon the gender desired. A pair of choices, in this case, may be presented to a human translator for further clarification or a machine translation may have determined a version based on a user profile.

In another example, a confidence score may be introduced, in the form of probability that the desired output for a word or phrase is correct. For example, using the previous word “made” when dealing with an article of manufacture wherein most of the time the article was made by a person of male gender, the confidence score would be higher for the male choice than the female choice.

Between translator adjustment server 802 may then be invoked at logical or physical hops in between translators as shown for adjustment module 816, between translators Chinese 808 and French 810, adjustment module 818 between translators French 810 and English 812 and adjustment module 820 between translators English 812 and Russian 814. Between translator adjustment server 802 may communicate with adjustment modules 816-820 wherein adjustment modules act as agents of the adjustment server in one embodiment or the adjustment server may be used as an adjustment module itself in another embodiment to accomplish the translation adjustments required.

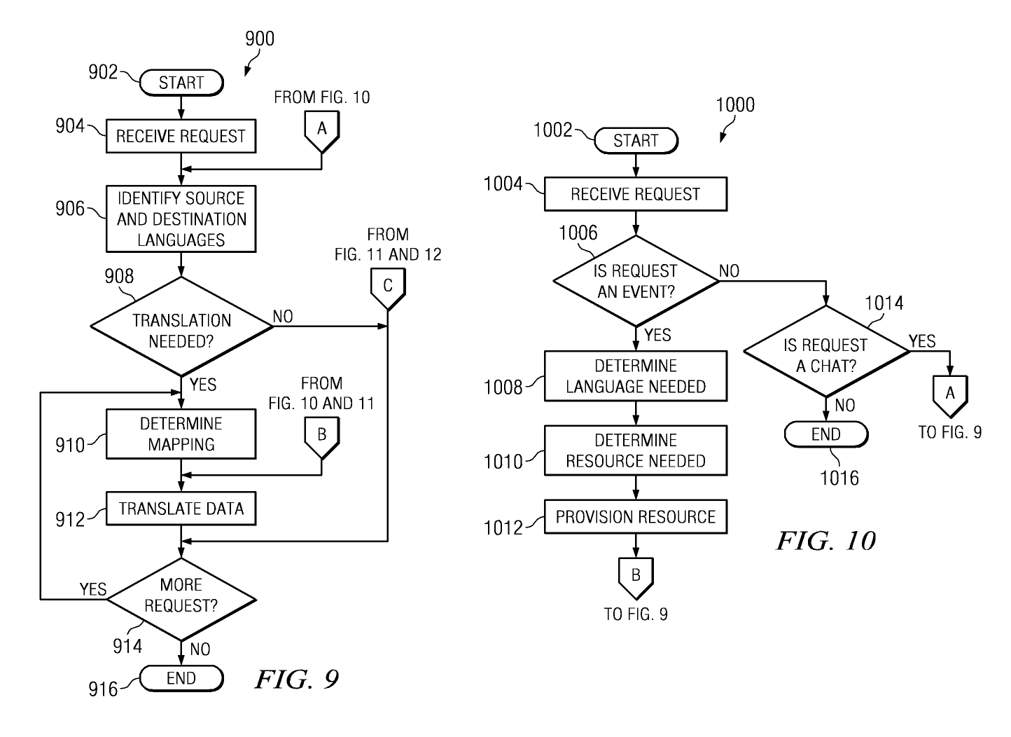

With reference to FIG. 9, a flowchart of an overview of a process of a translation service 300 of FIG. 3, in accordance with illustrative embodiments is shown. Process 900, as may be implemented in an embodiment of translation service 300 of FIG. 3, receives a request, and translates information between a source and destination language upon determination of a need for translation. Process 900 begins (step 902) and receives a request (step 904). The request, for example, may be from a user of a support center to resolve a product issue that involves communication with a support person of a different language.

The request may involve a series of successive requests, as in the sequence of a discussion in a dialog resolving a problem. The requests in the dialog imply translations in both directions, so that the source and destination may be reversed at a point in time from the previous point in time. Using the chat as an example, after sending a message, the flow reverses to enable a response chat message to be sent, thereby reversing the source and destination languages.

The sequence of the discussion may be monitored to detect changes, such as the dropping of a hop within a path or the change in personnel in the discussion. Either event may cause the translation requirements to be altered and require a new path calculation.

The request is reviewed to determine a source language of the requester and a destination language of the support person (step 906). The language pairs are compared to determine if a translation is required (step 908). If the languages are the same, a “no” response results, otherwise a “yes” results. If a “no” was determined in step 908, a determination is made whether another request is available (step 914).

However, if a “yes” result was obtained in step 908, a mapping from the source language to the destination language would be determined (step 910). Translations would be performed and results returned as indicated in step 910 (step 912). Process 900 determines if another request is available (step 914). If a “yes” result is obtained in step 914, process 900 moves to step 910 and processes as before. If there are no more requests, a “no” results in step 914 with process 900 terminating thereafter (step 916).

As an alternative, process 900 may save source and destination language information, and the reverse flow information, after initial use, to avoid further lookup processing during the session. Alternate paths may be established to have more than one path active to provide backup and recover ability if desired.

With reference to FIG. 10, a flowchart of a request receiving process of a translation service 300 of FIG. 3, in accordance with illustrative embodiments is shown. Request receiving process 1000 is an embodiment of an input portion, shown as step 904 of FIG. 9, of an embodiment of translation service 300. Process 1000 begins (step 1002) and receives a request (step 1004). As described in the previous example, the request typically involves a user and a support person but may also be another combination of source and destination entities.

Having received a request, the request is analyzed to determine whether the request is an event (step 1006). If a “yes” was obtained in step 1006, the language requirements are determined, namely the source and destination language combination (step 1008). Based on the languages determined, associated resources are determined (step 1010). Having determined the language based resource requirements, the appropriate resources are provisioned (step 1012) and process 1000 returns to point “B” of FIG. 9.

If a “no” was obtained in step 1006, the request would be examined to determine if the request involved a chat session (step 1014). A chat session in this example follows the previous example of a communication between a user of a support center and a support center person. If a “no” was obtained in step 1014, process 1000 terminates (step 1016). If a “yes” was obtained in step 1014, process 1000 returns to point “A” of FIG. 9.

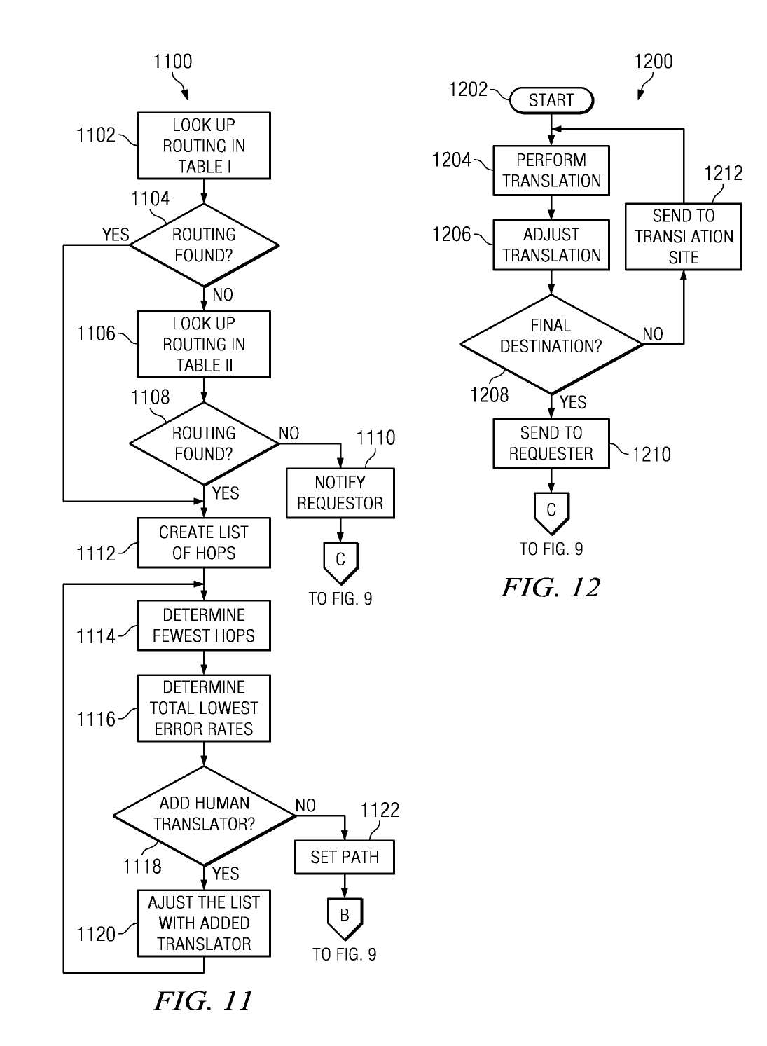

With reference to FIG. 11, a flowchart of a routing process of a translation service 300 of FIG. 3, in accordance with illustrative embodiments is shown. Routing process 1100 is an embodiment of a mapping portion, shown in step 910 of FIG. 9, of an embodiment of translation service 300. Process 1100 begins and determines the required routing by performing a lookup of the required routing using Table I (step 1102). Table I, as previously described provides direct language to language correspondence mapping.

The source language and destination language are used as input to the table lookup process. A determination is made whether the routing required has been found (step 1104). If a “yes” was obtained in step 1104, process 1100 skips to step 1112.

If a “no” was obtained in step 1104, a lookup is performed using Table II (step 1106). Table II as described previously defines mappings for multi-hop or multiple hop translations wherein there is no direct language to language translation capability. A determination is made whether the required mapping information is located within Table II (step 1108). If the required mapping information is found a “yes” results, otherwise a “no” is obtained. If a “no” was obtained in step 1108, the requester is notified (step 1110) and process 1100 returns to “C” of FIG. 9.

If a “yes” was obtained in step 1108, a list of hops is created (step 1112). From the list of hops, a determination of the shortest path having fewest hops is made (step 1114). The path with the lowest total error rate is determined (step 1116). Error rate is determined based on word error rate, language error, or speaker error, or a combination as required.

A determination is made whether a human translator is to be added (step 1118). A human translator may be added to correct errors or because there are no machine translators available for the language combination to be translated. In addition, there may be a need for a human translator depending upon the stage of translation, such as an end stage producing a readable transcription or a message summary.

If a “no” is obtained in step 1118 the path is set (step 1122) and process 1100 returns to point “B” in FIG. 9. If a “yes” is obtained in step 1118, the list of hops is adjusted with the addition of the human translator (step 1120) and process 1100 loops back to step 1114 to recalculate the path.

With reference to FIG. 12, a flowchart of a translation process of a translation service of FIG. 3, in accordance with illustrative embodiments is shown. Translation process 1200 is an embodiment of a translate data portion, shown in step 912 of FIG. 9, of an embodiment of translation service 300. Process 1200 begins (step 1202) and performs the requested translation using resources previously determined based on the language combination provided (step 1204). The initial translation from step 1204 is adjusted to improve the translated result (step 1206). Adjustment is performed by an adjustment server 802 and adjustment module 816 of FIG. 8.

A determination is made whether the translation output is to be sent to a final destination (step 1208). If the output is to be sent to a final destination a “yes” response is obtained, otherwise a “no” response results. If a “yes” was obtained, the translation output is sent to the requester (step 1210) and process 1200 returns to point “C” of FIG. 9. If a “no” result was obtained from step 1208, an intermediate translation is presumed and the translation output is sent to the next translation site (step 1212). The next translation site would be identified in the routing or determine mapping step of FIG. 9.

Illustrative embodiments provide a capability to connect users and support personnel of different languages allowing each to communicate in their native language when supported by the system. A network, such as network 102 in FIG. 1, may be used to connect translation resources, combining automatic machine, as well as manual operations to create a communication link between a user and a help desk support personnel. In one illustrative embodiment, the help desk may be supported on server 106 and translation services on server 104, while a user is represented by client 110 communicating through network 102.

The translation resources cooperate to translate online information, including, but not limited to, chats and emails, in substantially real time between a source language of a client, such as client 110 and a destination language of support personnel on server 106. Routing information may support direct translation of language to language or multi-hop translation. Multi-hop translation involves a path of multiple translation sites to perform the translation from a source language to a destination language through a set of language translations because a direct translation capability does not exist. Other resources described provide a capability to adjust the translation output using performance statistics obtained from monitoring the system, thereby incrementally improving the translation output.

The invention can take the form of an entirely hardware embodiment, an entirely software embodiment or an embodiment containing both hardware and software elements. In a preferred embodiment, the invention is implemented in software, which includes, but is not limited to, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable recordable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including, but not limited to, keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for optimizing a natural language translation, the computer implemented method comprising:
receiving a request from a requester, wherein the request comprises source language data an indication of a source language and a destination language;
determining whether a translation between the source language and the destination language is needed;
identifying a mapping between the source language and the destination language, wherein the mapping includes a set of hops in response to a determination that the translation is needed;
translating the source language data into a destination language data associated with each successive hop in the set of hops in the mapping by a set of translators; and
returning the destination language data to the requester at a destination hop.

2. The computer implemented method of claim 1, wherein receiving the request further comprises:
determining whether the request is an event;
responsive to a determination that the request is an event, further determining a natural language required and a corresponding resource; and
provisioning the corresponding resource.

3. The computer implemented method of claim 1, wherein identifying a mapping between the source language and the destination language further comprises:
identifying a specific mapping through locating routing information in a first repository;
identifying a specific mapping through locating routing information in a second repository; and
routing the translations in accordance with the routing information of the specific mapping, otherwise notifying the requester.

4. The computer implemented method of claim 1, wherein translating the source language data into a destination language data further comprises:
creating intermediate translated destination language data from the translation of the source language data into the destination language data;
adjusting the intermediate translated destination language data to create adjusted destination language data;
determining whether the adjusted destination language data is to be sent to a final destination; and
sending the adjusted destination language data responsive to determining the destination is final.

5. The computer implemented method of claim 4, wherein sending the adjusted destination language data sends the adjusted destination language data to a next successive hop in the set of hops.

6. The computer implemented method of claim 4, wherein adjusting the intermediate translated destination language data further comprises:
using an adjustment server and a set of adjustment modules, wherein each adjustment module of the set of adjustment modules is located between successive hops.

7. An apparatus for optimizing a natural language translation, the apparatus comprising:
a bus;
a memory connected to the bus;
a persistent storage connected to the bus, wherein the persistent storage contains computer usable program code therein;
a communications unit;
a display unit; and
a processor unit connected to the bus, wherein the processor unit executes the computer usable program code to:
receive a request from a requester, wherein the request comprises source language data, an indication of a source language and a destination language;
determine whether a translation between the source language and the destination language is needed;
identify a mapping between the source language and the destination language wherein the mapping includes a set of hops, in response to a determination that the translation is needed;
translate the source language data into a destination language data associated with each successive hop in the set of hops in the mapping by a set of translators; and
return the destination language data to the requester at a destination hop.

8. The apparatus of claim 7, wherein the processor unit executes the computer usable program code to receive a request further comprises:
a capability to determine whether the request is an event and responsive to a determination that the request is an event further determining a natural language required and a corresponding resource; and
a capability to provision the corresponding resource.

9. The apparatus of claim 7, wherein the processor unit executes the computer usable program code to identify a mapping between the source language and the destination language further comprises:
a capability of identifying a specific mapping through locating routing information in a first repository;
a capability of identifying a specific mapping through locating routing information in a second repository; and
a capability of routing the translations in accordance with the routing information of the specific mapping, otherwise notifying the requester.

10. The apparatus of claim 7, wherein the processor unit executes the computer usable program code to translate the source language data into a destination language data further comprises:
a capability of creating intermediate translated destination language data from the translation of the source language data into the destination language data;
a capability of adjusting the intermediate translated destination language data to create adjusted destination language data;
a capability of determining whether the adjusted destination language data is to be sent to a final destination; and
a capability of sending the adjusted destination language data responsive to determining the destination is final.

11. The apparatus of claim 10, wherein the processor unit executes the computer usable program code to send the adjusted destination language data to a next successive hop in the set of hops.

12. The apparatus of claim 10, wherein the processor unit executes the computer usable program code to adjust the intermediate translated destination language data further comprises:
a capability of using an adjustment server and a set of adjustment modules, wherein each adjustment module of the set of adjustment modules is located between successive hops.

13. A computer program product for optimizing a natural language translation, the computer program product comprising a computer usable recordable type medium having computer executable program code tangibly embodied thereon, the computer executable program code comprising:
computer executable program code for receiving a request from a requester, wherein the request comprises source language data, an indication of a source language and a destination language;
computer executable program code for determining whether a translation between the source language and the destination language is needed;
computer executable program code for identifying a mapping between the source language and the destination language, wherein the mapping includes a set of hops in response to a determination that the translation is needed;
computer executable program code for translating the source language data into a destination language data associated with each successive hop in the set of hops in the mapping by a set of translators; and
computer executable program code for returning the destination language data to the requester at a destination hop.

14. The computer program product of claim 13, wherein the computer executable program code for receiving the request further comprises:
computer executable program code for determining whether the request is an event and responsive to a determination that the request is an event further determining a natural language is required and a corresponding resource; and
provisioning the corresponding resource.

15. The computer program product of claim 13, wherein the computer executable program code for identifying a mapping between the source language and the destination language further comprises:
computer executable program code for identifying a specific mapping through locating routing information in a first repository;
computer executable program code for identifying a specific mapping through locating routing information in a second repository; and
computer executable program code for routing the translations in accordance with the routing information of the specific mapping, otherwise notifying the requester.

16. The computer program product of claim 13, wherein the computer executable program code for translating the source language data into a destination language data further comprises:
computer executable program code for creating intermediate translated destination language data from the translation of the source language data into the destination language data;
computer executable program code for adjusting the intermediate translated destination language data to create adjusted destination language data;
computer executable program code for determining whether the adjusted destination language data is to be sent to a final destination; and
computer executable program code for sending the adjusted destination language data responsive to determining the destination is final.

17. The computer program product of claim 16, wherein the computer executable program code for sending the adjusted destination language data comprises:
computer executable program code for sending the adjusted destination language data to a next successive hop in the set of hops.

18. The computer program product of claim 16, wherein the computer executable program code for adjusting the intermediate translated destination language data further comprises:
computer executable program code for using an adjustment server and a set of adjustment modules, wherein each adjustment module of the set of adjustment modules is located between successive hops.
